(19) United States
(12) Patent Application Publication
(10) Pub. No.: US 2005/0279059 A1
(43) Pub. Date: Dec. 22, 2005

(54) Air purifier and control method thereof

(75) Inventors: Jai Kwon Lee, Suwon-Si (KR); Jae Oh Han, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/150,267

(22) Filed: Jun. 13, 2005

(30) Foreign Application Priority Data
Jun. 22, 2004 (KR) 2004-46590

(51) Int. Cl. B01D 46/00

(52) U.S. Cl. 55/356

(57) ABSTRACT

An air purifier and a method for controlling the same, where the air purifier has a uniformly high air-purifying efficiency throughout an overall indoor space having a complicated structure or broad dimensions. The air purifier includes a main body including an air-purifying filter; and a transport unit adapted to move the main body about a cleaning area. The method for controlling the air purifier includes: detecting a pollution level in a cleaning area; comparing the detected pollution level to a first reference value; determining which of a moving purification and a stopped purification is required based on the comparison; performing the stopped purification while the air purifier remains at a first location in the cleaning area when the stopped purification is required; and performing the moving purification while moving the air purifier about the cleaning area when the moving purification is required.

### CROSS-REFERENCE TO RELATED APPLICATION

This application is based upon and claims the benefit of priority from Korean Patent Application No. 2004-46590, filed Jun. 22, 2004, in the Korean Intellectual Property Office, the disclosure of which is incorporated herein in its entirety by reference.

### BACKGROUND OF THE INVENTION

1. Field of the Invention

The invention relates to an air purifier and a control method thereof, and more particularly to an air purifier which moves indoors and purifies indoor air, and a control method thereof.

2. Description of the Related Art

An air purifier is an apparatus for removing dust, bacteria, and other contaminants from air, and for supplying purified clean air. Generally, a dust collector for collecting dust from air and/or a deodorization filter for removing odor from air are installed in the air purifier.

A cover is installed on the front surface of a main body of the air purifier, and a plurality of air inlets for inhaling air into the inside of the main body are formed through the cover. When contaminated air is inhaled into the main body through the air inlets, the contaminated air passes through a filter unit installed in the main body so that the contaminated air is purified by removing dust, noxious ingredients, and odors therefrom, and the obtained purified air is discharged to the outside through air outlets formed through the rear surface of the main body. A pollution level detecting sensor for detecting the pollution level of the indoor air is installed on a side surface of the main body. An air blast fan for forcibly circulating the indoor air from the front surface of the main body to the rear surface of the main body is installed at the rearmost portion of the inside of the main body. When the air blast fan is rotated, an air current flowing from the front surface to the rear surface of the main body is formed, thereby circulating the indoor air.

As described above, the indoor air passes through the filter of the air purifier, and is circulated by the rotation of the air blast fan, thereby being purified. However, when an indoor space has a large volume or includes a wall or furniture, it is difficult to efficiently circulate the air throughout the indoor space. Accordingly, there has been required a method for efficiently and smoothly circulating air in an indoor space having a large volume and/or a complicated structure.

### SUMMARY OF THE INVENTION

Therefore, an aspect of the invention is to provide an air purifier, which has a uniformly high air-purifying efficiency throughout an overall indoor space having a complicated structure or large dimensions, and a method for controlling the same.

In accordance with one aspect, the invention provides an air purifier including: a main body including an air-purifying filter; and a transport unit adapted to move the main body about a cleaning area.

In accordance with another aspect, the invention provides a method for controlling an air purifier including: detecting a pollution level in a cleaning area; comparing the detected pollution level to a first reference value; determining which of a moving purification and a stopped purification is required based on the comparison; performing the stopped purification while the air purifier remains at a first location in the cleaning area when the stopped purification is required; and performing the moving purification while moving the air purifier about the cleaning area when the moving purification is required.

### BRIEF DESCRIPTION OF THE DRAWINGS

These and/or other aspects, features and advantages of the invention will become apparent and more readily appreciated from the following description of the exemplary embodiments thereof, taken in conjunction with the accompanying drawings in which:

FIG. 1 is a perspective view of an air purifier in accordance with an exemplary embodiment of the invention;

FIG. 2 is a block diagram illustrating a system for controlling the air purifier in accordance with an exemplary embodiment of the invention;

FIG. 3 is a flow chart illustrating a method for controlling the air purifier in accordance with an exemplary embodiment of the invention; and

FIG. 4 is a flow chart illustrating a method for controlling an air purifier in accordance with another exemplary embodiment of the invention.

### DETAILED DESCRIPTION OF EXEMPLARY EMBODIMENTS

Exemplary embodiments of the invention will now be described below by reference to the accompanying drawings, wherein like reference numerals refer to like elements throughout. The described exemplary embodiments are intended to assist the understanding of the invention, and are not intended to limit the scope of the invention in any way.

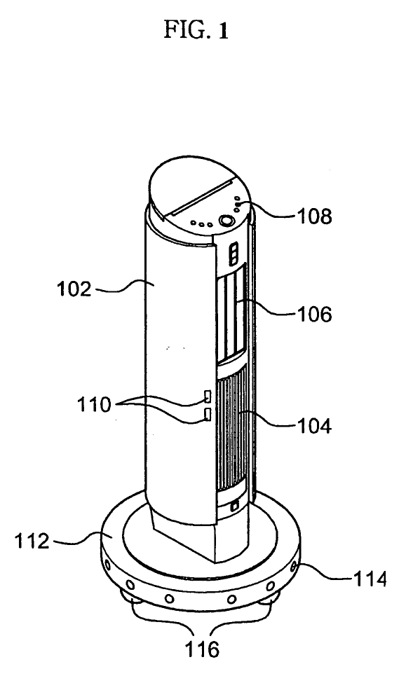

FIG. 1 is a perspective view of an air purifier in accordance with an exemplary embodiment of the invention. As shown in FIG. 1, the air purifier includes a main body 102 and a transport unit 112. An air-purifying filter and an air blast fan are installed in the main body 102. A driving unit (e.g., a motor) for driving wheels 116 to move the main body 102, a control unit for controlling the driving unit, and a power supply unit for supplying power are installed in the transport unit 112.

Air inlets 104, air outlets 106, an input unit 108, and a pollution level detecting unit 110 are formed on the external surface of the main body 102. Here, the input unit 108 serves to allow a user to input an operation mode, such as a move mode or a stop mode, or a predetermined value. The pollution level detecting unit 110 serves to detect a pollution level and a contaminant type based on the distribution of the contaminants in air. The contaminants mainly include odor and dust.

A navigation device 114, which is installed along the external surface of the transport unit 112, serves to sense the moving direction and moving distance of the main body 102, and obstacles when the main body 102 moves, and to supply the obtained data to the control unit 202.

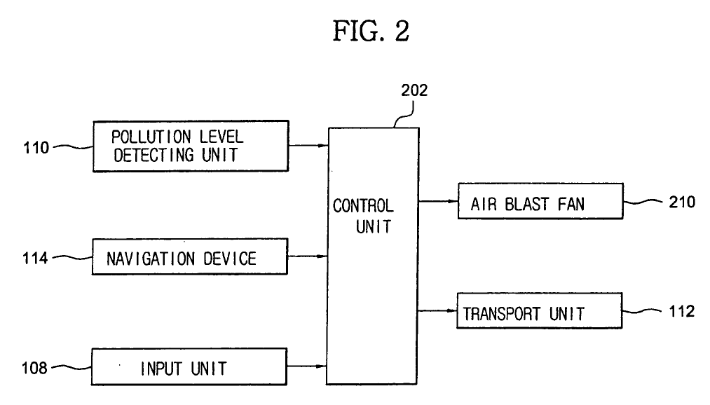

FIG. 2 is a block diagram illustrating a system for controlling the air purifier in accordance with an exemplary embodiment of the invention. As shown in FIG. 2, the pollution level detecting unit 110, the navigation device 114, and the input unit 108 are connected to an input side of the control unit 202 for controlling the overall operation of the air purifier. The air blast fan 210 and the transport unit 212 are connected to an output side of the control unit 202.

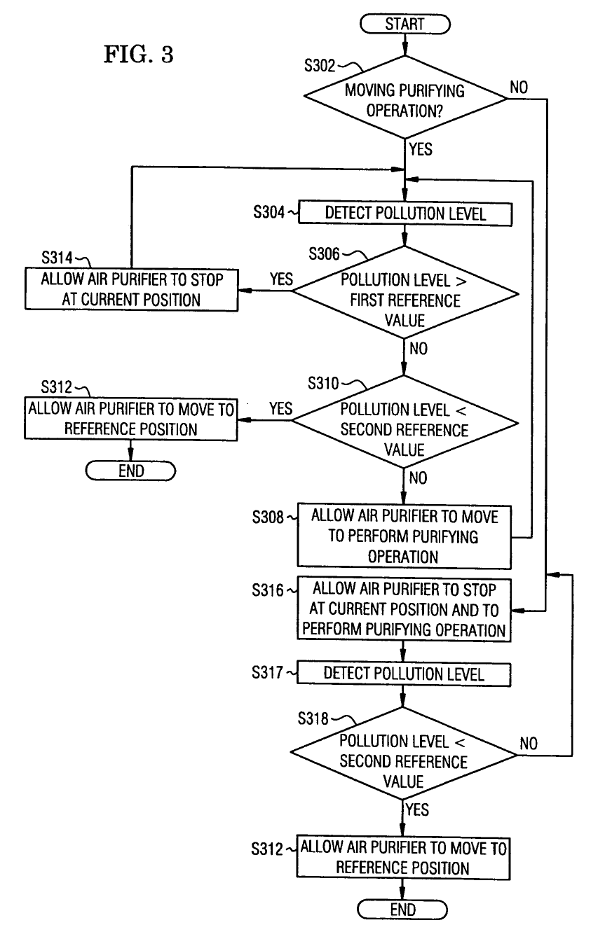

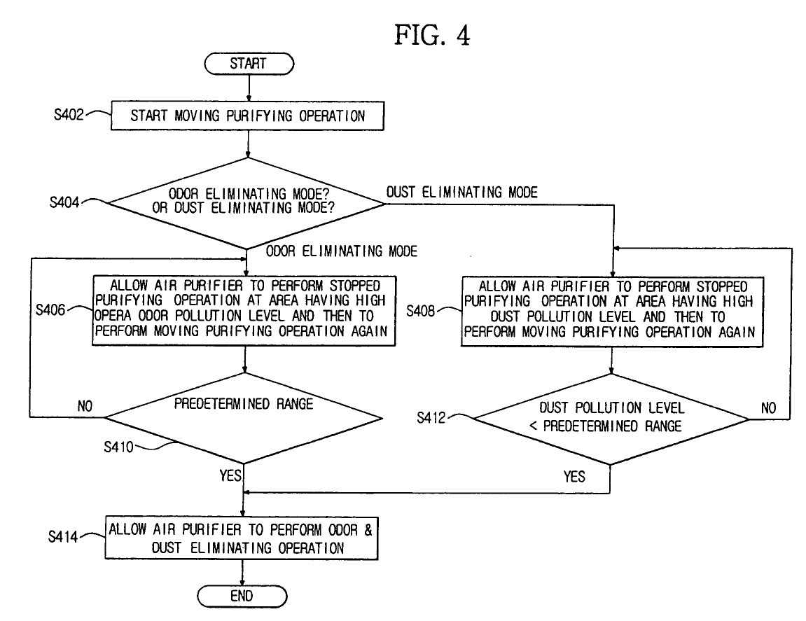

The control unit 202 performs air purification at a local area in the stopped state of the air purifier, or performs air purification at a wide area in the moving state of the air purifier, according to a user's mode-setting. Further, the control unit 202 divides the contaminants mainly into odor and dust, and then separately performs a purifying operation for eliminating odor, a purifying operation for eliminating dust, or a combined purifying operation for simultaneously eliminating odor and dust according to the user's mode-setting. Hereinafter, with reference to FIGS. 3 and 4, the above control method using the control unit 202 will be described in detail.

FIG. 3 is a flow chart illustrating a method for controlling the air purifier in accordance with an exemplary embodiment of the invention. In this method, according to the pollution level, a stopped purifying operation, in which the air purifier is stopped and concentrically purifies air in a local area from the current position, and a moving purifying operation, in which the air purifier moves throughout a predetermined area and uniformly purifies air in an overall area, are selectively performed. Further, when the pollution level of a specific area exceeds a predetermined range during the moving purifying operation, the air purifier is stopped at the above area, performs the stopping purifying operation, and then performs again the moving purifying operation.

As shown in FIG. 3, when the operation mode set by the user is the moving purifying operation mode (S302), the pollution level detecting unit 110 detects the pollution level (S304). When the detected pollution level is less than a first predetermined reference value (the upper limit of a predetermined range) (S306) and more than a second predetermined value (S310), the air purifier continuously moves in a designated indoor space, and performs the moving purifying operation (S308). If the pollution level of the indoor space is not more than the second predetermined reference value (the lower limit of the predetermined range) (S310), the air purifier moves to a predetermined reference position, and is then stopped at this position (S312). Here, the first predetermined reference value denotes the high pollution level so that the air purifier of the exemplary embodiment of the invention is stopped at a designated position and locally performs the purifying operation, and the second predetermined reference value denotes the low pollution level so that the purifying operation of the air purifier is sufficiently performed and is not required any more. In this embodiment, the second reference value is smaller than the first reference value.

When the pollution level exceeds the first reference value (S306), the air purifier is stopped at the current position and performs the stopped purifying operation (S314), thereby lowering the pollution level at the corresponding position more rapidly than the moving purifying operation (S308).

When the operation mode set by the user is the stopped purifying operation mode, the air purifier is stopped at the current position and performs the stopped purifying operation (S316). The pollution level is then detected (S317), and when the pollution level is lowered not more than the second reference value by the above stopped purifying operation (S318), the air purifier moves to the reference position, and is then stopped at this position (S312).

FIG. 4 is a flow chart illustrating a method for controlling an air purifier in accordance with another exemplary embodiment of the invention. In this method, the air purifier first performs the stopped purifying operation at an area having a high pollution level of contaminant according to the contaminant types (odor or dust). As shown in FIG. 4, the moving purifying operation is performed (S402). Then, it is determined which mode is selected by a user, and an odor eliminating mode or a dust eliminating mode is first performed based on the user's mode-setting (S404).

When the operation mode set by the user is the odor eliminating mode, the air purifier performing a moving odor and dust eliminating operation is stopped at an area having a high odor pollution level (i.e., an area where the odor pollution level is higher than the first reference value described in FIG. 3), where it performs the stopped purifying operation. The air purifier then is released to perform a moving odor purifying operation (S406). Thereafter, when the odor pollution level is not more than the second reference value (i.e., not more than the lower limit of the predetermined range) (S410), the air purifier returns to performing the odor and dust eliminating operation (S414).

On the other hand, when the operation mode set by the user is the dust eliminating mode, the air purifier performing the moving odor and dust eliminating operation is stopped at an area having a high dust pollution level (i.e., an area where the dust pollution level is higher than the first reference value described in FIG. 3), where it performs the stopped purifying operation. The air purifier is then released to perform a moving dust purifying operation (S408). Thereafter, when the dust pollution level is not more than the second reference value (i.e., not more than the lower limit of the predetermined range) (S412), the air purifier returns to performing the odor and dust eliminating operation (S414). The purifying operations of steps S406 and S408 of FIG. 4 are the same as those of step S304, S306, S308, and S314 of FIG. 3.

As apparent from the above description, the invention provides an air purifier, which uniformly purifies air throughout an overall indoor space having a complicated structure or broad dimensions, and a method for controlling the same. Particularly, when a partial area of the indoor space has a severely high pollution level, the air purifier of the invention is stopped at this area, and locally performs the concentrated purifying operation, thereby having a uniformly high air-purifying efficiency throughout the overall indoor space.

While the invention has been particularly shown and described with reference to exemplary embodiments thereof, the invention is not limited to these embodiments. It would be appreciated by those of ordinary skill in the art that various changes in form and details may be made to these embodiments without departing from the principles, spirit and scope of the invention, as defined in the following claims and their equivalents.

1. An air purifier comprising:
a main body comprising an air-purifying filter; and
a transport unit adapted to move the main body about a cleaning area.

2. The air purifier as set forth in claim 1, wherein the transport unit comprises powered wheels.

3. The air purifier as set forth in claim 1, further comprising a control unit adapted to control the transport unit to move the main body.

4. The air purifier as set forth in claim 1, wherein the main body further comprises a fan adapted to pass air through the air-purifying filter.

5. The air purifier as set forth in claim 1, wherein:
the main body further comprises an input unit adapted to allow a user to select an operative mode of the air purifier, and a control unit adapted to control the transport unit to move the main body; and
the control unit controls the transport unit to move the main body in accordance with the operative mode.

6. The air purifier as set forth in claim 5, wherein the operative mode is one of a move mode and a stop mode.

7. The air purifier as set forth in claim 1, wherein:
the main body further comprises a pollution level detecting unit adapted to detect a pollution level in the cleaning area, and a control unit adapted to control the transport unit to move the main body; and
the control unit is adapted to analyze an output value of the pollution level detecting unit, and to determine whether or not to control the transport unit to move the main body based upon the analysis.

8. The air purifier as set forth in claim 7, wherein:
the control unit is adapted to control the transport unit to stop the main body at a first position in the cleaning area and perform air purification when the pollution level at the first position exceeds a reference value; and
the control unit is adapted to control the transport unit to move the main body about the cleaning area and perform air purification when the pollution level at the first position is less than the reference value.

9. The air purifier as set forth in claim 1, wherein the transport unit comprises:
wheels;
a power unit adapted to drive the wheels; and
a navigation device adapted to obtain information regarding a moving direction and a moving distance of the main body and obstacles in the cleaning area.

10. A method for controlling an air purifier, comprising:
detecting a pollution level in a cleaning area;
comparing the detected pollution level to a first reference value;
determining which of a moving purification and a stopped purification is required based on the comparison;
performing the stopped purification while the air purifier remains at a first location in the cleaning area when the stopped purification is required; and
performing the moving purification while moving the air purifier about the cleaning area when the moving purification is required.

11. The method as set forth in claim 10, wherein the detecting a pollution level is performed using a pollution level detecting unit.

12. The method as set forth in claim 10, wherein the performing of the stopped purification and the performing of the moving purification comprise driving an air blast fan.

13. The method as set forth in claim 10, wherein the moving of the air purifier comprises driving a transport unit.

14. The method as set forth in claim 13, wherein the transport unit comprises powered wheels.

15. The method as set forth in claim 10, further comprising, when performing the moving purification:
detecting a new pollution level at a second position in the cleaning area;
comparing the detected new pollution level to the first reference value;
stopping the air purifier at the first position when the pollution level exceeds the first reference value and performing the stopped purification while the air purifier remains at the second position; and
continuing to perform the moving purification when the pollution level does not exceed the first reference value.

16. The method as set forth in claim 10, further comprising:
comparing the detected pollution level to a second reference value;
stopping the performing of either stopped purification or moving purification when the pollution level is less than the second reference value; and
moving the air purifier to a standby position.

17. The method as set forth in claim 13, wherein the transport unit includes:
wheels;
a power unit adapted to drive the wheels; and
a navigation device adapted to obtain information regarding a moving direction and a moving distance of the main body and obstacles in the cleaning area.
